(19) United States
(12) Patent Application Publication
(10) Pub. No.: US 2021/0000222 A1
(43) Pub. Date: Jan. 7, 2021

(54) Reformable Insole and Method of Fabricating

(71) Applicant: Jason Guadalajara, Covina, CA (US)

(72) Inventor: Jason Guadalajara, Covina, CA (US)

(21) Appl. No.: 17/021,887

(22) Filed: Sep. 15, 2020

Related U.S. Application Data
(63) Continuation-in-part of application No. 14/325,353, filed on Jul. 7, 2014, now abandoned.

(51) Int. Cl. A43D 35/00; A43B 17/14; B29C 39/02; B29C 35/02; B29D 35/12

(52) U.S. Cl. CPC A43D 35/00; A43B 17/14; B29D 35/122; B29C 35/0288; B29C 39/02

(57) ABSTRACT

An apparatus including means for being remoldable with application of heat at a predetermined temperature, means for absorbing the remoldable means, and means for enclosing the absorbing means, wherein the enclosing means comprises a substantially sealed enclosing means configured to resist a leakage of the absorbing means saturated with the remoldable means. The apparatus further include a insole implement, in which the insole implement having an insole section and an arch pad area, wherein the arch pad area is operable for accepting the enclosing means, wherein the insole implement is operable for maintaining a molded shape as the heat activated and remoldable resin composition in the sealed chamber implement cools in temperature, and wherein the insole implement is further configured to be operable for being remolded to a different shape by reheating the enclosing means containing the absorbing means saturated with the remoldable means.

### RELATED CO-PENDING U.S. PATENT APPLICATIONS

The following related U.S. patent application(s), submitted by at least one of the present Applicant(s)/Inventor(s) is/(are) recently co-pending: U.S. utility patent application Ser. No. 14/325,353, entitled “An Insole and Method of Fabricating”, submitted to the United States Patent and Trademark Office (USPTO) on Jul. 7, 2014. U.S. The contents of this related patent application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to insoles or inserts for shoes. More particularly, the invention relates to custom made insoles or inserts for shoes and a method of making them.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. Some conventional approaches attempt to custom form an insole inside a shoe, by using an expandable uncured resin such as a moisture cured polyurethane foam. While it is effective for making a custom mold, the custom mold could only be cured once.

By way of educational background, another aspect of the prior art generally use expandable uncured resins which need a catalyst to activate. The most common catalyst is moisture. Generally, practitioners are concerned about the risk of moisture easily invading the insole and activate the uncured resin during production or on the way to consumer. Most of the expandable resins are very sensitive and also have a short shelf life of three to twelve months. Therefore, it is unrealistic to bring this product to market and global distribution as it can take many months for production, logistics and finally shipping to retail stores or distributors and many more months until a customer purchases it. By the time the end customer attempts to mold the product, it is very like moisture has already set off the reaction. The expandable uncured resins also cannot be remolded if a customer makes a mistake. Expandable resins also contain Methyl di-p-phenylene isocyanate (MDI) which is known to cause severe allergic reactions to some people and are considered highly toxic and should not be given to consumers in uncured form.

A problem in the prior art method of making custom insoles is that it was only a one time cure after reacting with the curing agent. Once the insole is cured for the first time, it would not be able to be refitted or reshaped. The inability to remold the insoles when using a new pair of shoes or boots makes it uncomfortable in many situations and unusable in some shoes. If any mistakes are made during the curing process, the insoles are ruined.

Another problem in the prior art method of making custom insoles is that the curing agent would also spill out of the insole when injected or introduced, making the soles and shoes wet during the molding process and potentially exposing the skin to the curing agent and resin.

Some of the prior art custom insoles are heat moldable insoles being hollow under the arch, and they are easy to collapse with body weight, and thus not be able to support the feet as orthotics. Some of the prior art custom insoles use heat cured resin mixed with cork. When heated, the cork could be slightly molded. Generally, practitioners are concerned about the risk of the cork not expanding as resin, and thus it will not fit most people's arch height.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-D illustrate an exemplary method of resettable or reformable resin forming custom insoles in accordance with an embodiment of the present invention;

FIGS. 2A-C illustrate an exemplary method of customizing an insole in accordance with an embodiment of the present invention; and

FIG. 3 illustrates a flow chart of an exemplary method of customizing an insole in accordance with an embodiment of the present invention.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

The present embodiment may use a stable heat activated and remoldable resin composition which is resettable or reformable by heating. Instead of expanding to cure in a specific shape or mold, the resin may lock a foam into a specific shape until the resin is reactivated at which point it may release the hold on the foam which can return to its original shape to be molded again. In an embodiment, foam to be impregnated with the heat activated and remoldable resin composition may comprise of an open cell foam, wherein the open cell foam may include a rubber-like compound by incorporating an inflating agent, such as sodium bicarbonate, into the rubber compound. The inflating agent may give off a gas, which may expand the rubber compound during vulcanization. A foam is typically classified as “open cell” when more than half of the foam cells are open. The heat activated and remoldable resin may become hard in its dormant state which may provide firm and stable custom support that foam alone cannot achieve. For instance, hot melt glue are generally a solid formulation in dormant states based on resin and rubber composition. The rubber based hot melt glue are generally solid at room temperature and are activated upon heating above its softening temperature point, at which stage the rubber based hot melt glue are liquid, and therefore may be processed to a different shape or form.

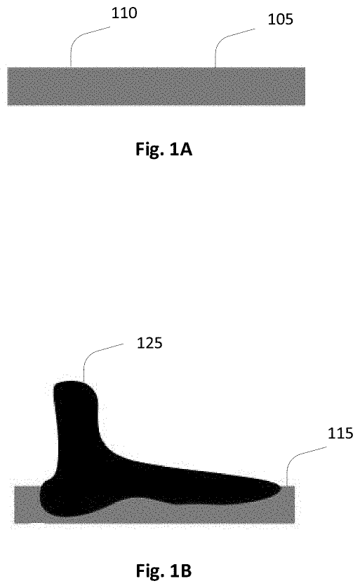

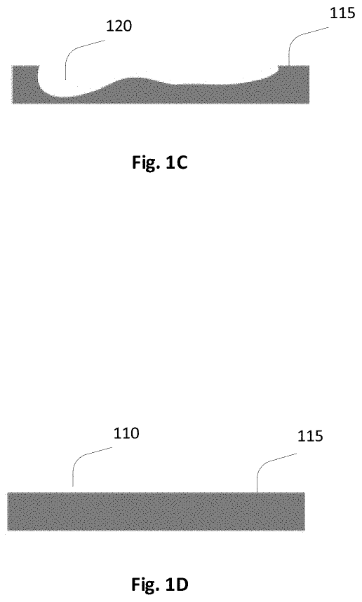

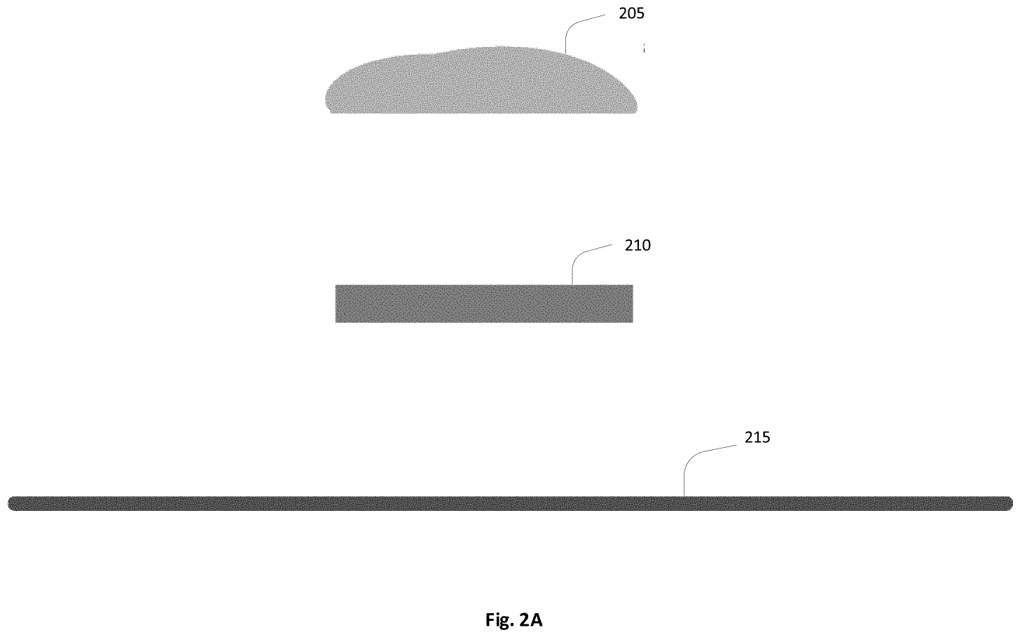

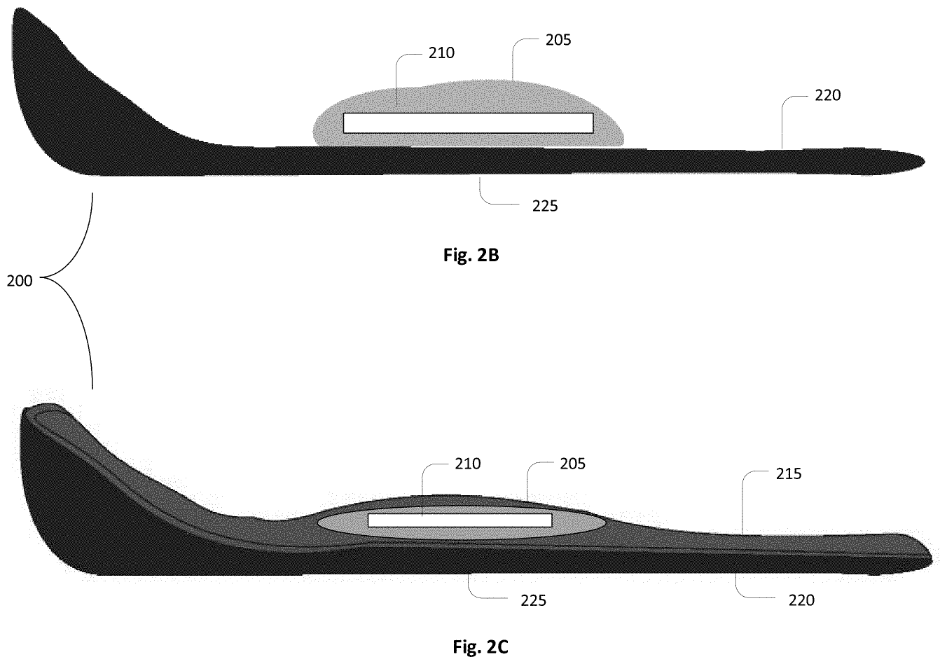

FIGS. 1A-D illustrates an exemplary method of a resettable or reformable resin composition forming custom insoles 200 (see FIG. 2B-2C) in accordance with an embodiment of the present invention. An example of a foam 105, such as but not limited to an open cell foam illustrated by way of example in FIG. 1A, may be impregnated with the resettable or reformable resin composition 115, is illustrated by way of example in FIG. 1B. While the foam 105 is in the soft state and original shape 110, the resin composition is activated by heating to the resin composition softening point, and a pressure is applied by an object, such as a foot 125, which may mold or shape the foam impregnated with the heat activated and remoldable resin composition 115, by way of example in FIG. 1B. When the foam impregnated with heat activated and remoldable resin composition 115 is in the hard or dormant state, the object to be molded, such as the foot 110, may be removed when the foam impregnated with the heat activated and remoldable resin 115 sets, leaving impregnated foam 115 custom mold 120, by way of example in FIG. 1C. If remolding is desired/needed, reheat the foam impregnated with the heat activated and remoldable resin composition 115 to the softening temperature point, which may enable the resin impregnated foam 115 to rise again to the original shape 110 due to the nature of the open cell foam and can be remolded for any foot again, by way of example in FIG. 1D. In many embodiments, the remoldable resin impregnated foam 115 may be heated to the softening temperature point with various typed of heating devices such as, but not limited to, an oven, toaster oven, etc. In some embodiments, different resin compositions may be designed to activate at different temperatures. For instance, hot melt glue may comprise of synthetic resin and rubber material which may have various hi-viscosity liquid flow rate when in melted or softened liquid form at various heating temperatures to easily saturate the foam and form a firm solid state with elasticity when in the dormant state. In one embodiment, rubber based hot melt glue are generally solid formulations in their dormant state. For example, the glue are solid at room temperature and are activated upon heating above the glue's softening point, at which stage they are liquid, and hence may enable to saturate the foam at various temperatures. Hot melt TPU glue may comprise of a heat-sensitive polyester-based thermoplastic polyurethane that can be used in a variety of settings from molding to traditional hot melt applications. The TPU may further comprise of water resistance capabilities and non-toxic properties.

FIGS. 2A-C illustrates an exemplary method of customizing an insole in accordance with an embodiment of the present invention. FIG. 2A illustrates elements needed to customize insole 200 (FIG. 2B-2C), including a heat resistant bag 205, an open cell foam impregnated with heat activated and remoldable resin composition 210, and a top layer 215. The heat resistant bag 205 can be a temperature resistant bag, such as, but not limited to, an aluminum vacuum sealed bag and a temperature resistant plastic bag, to act as a chamber if using a heat activated and remoldable resin composition. The open cell foam impregnated with heat activated and remoldable resin composition 210 may be placed at predetermined arch area 225 of the insole 200 that may support an arch of a foot and/or provide an arch pad. The arch foam impregnated with heat activated and remoldable resin composition 210 is formed by activating the resettable or reformable resin and saturating the open cell foam with the resin so the open cells of the foam become filled with the resin.

Those skilled in the art, in light of the teachings of the present invention, will readily recognize that there are an array of open cell foam materials, but generally they are made of but not limited to Polyurethane, reticulated Polyurethane, PVC/Nitrile, EPDM rubber etc. In alternate embodiments, a closed cell foam such as, but not limited to, Ethylene Vinyl Acetate (EVA), Polyethylene foam, Neoprene foam, PVC/Nitrile foam rubber, SBR foam rubber, etc. may be used without a bag. Open cell foam materials have tiny cells which are not completely closed. The open cells may be filled with air and this affects the way the open cell foam material feels and performs. Closed cell foam has cells which are sealed off so air doesn't get inside the structure at all. Open cell foam materials are softer and springier, where this foam type may offer superior comfort and support for a range of applications. While obvious solutions include cushions for residential seating such as sofas and chairs, foam fill sacks, commercial uses ranging from car seat manufacturing to mattresses, and much more, this type of foam may be used for a range of solutions. With the superior comfort it offers, the open cell foam material may be used in all manner of sofas, chairs, loveseats, and mattresses. The open cell foam material may be available in varying levels of firmness and density, where open cell foam material may be super soft or firmer for more support. The open cell foam material may be used in supporting aids, pillows, pet beds, etc. The top layer 215 can be a performance foam or any other cushion, such as, but not limited to, EVA, open cell polyurethane foam, closed cell poly urethane foam, leather or lamb skin, poly ethylene, or other types of foam suitable for insoles. Those skilled in the art, in light of the teachings of the present invention, will readily recognize a multiplicity of alternative and suitable means for the temperature resistant bag and top layer.

By way of an example in FIG. 2B, in order to avoid a mess or leakage of the heat activated and remoldable resin during remolding, place the resin impregnated foam 210 in a heat resistant bag 205 and vacuum seal the bag, and then place the bag in a predetermined arch area 225 of insole 200 of bottom layer 220. The heat activated and remoldable resin impregnated foam 210 vacuum sealed in heat resistant bag 205, may function as an arch pad. After placing the top layer 215 on top of the bottom layer 220 and vacuum sealed resin impregnated foam 210, the insole 200 may be sealed, by way of example in FIG. 2C. At this stage, the insole 200 with resin impregnated foam 210 vacuum sealed in heat resistant bag 205, placed in predetermined arch area 225 ready to mold. In another embodiment, the heat resistant bag 205 may not be used, and the impregnated foam 210 may be encased in a closed cell foam instead of an open cell foam as mentioned above. In many practical applications, the heat resistant bag 205 does not have to be elastic, often it needs to just be loose enough to fit the full foam insert at its full height. In many case, the amount of foam applied will usually determine the max height of the arch pad and may, thus, be varied depending on factors such as, without limitation size of insole being made, or women's vs mens shoes. The exact value may be determined by an engineer in light of the teaching of the present invention, yet on average 7-8 mm high is suitable in many common applications. Then it may be molded to any suitable height and/or shape within practical limits. In some embodiments, an injection molded insole with closed cell or unbreathable skin may be used where the resin composition may be injected into a chamber or heat resistant bag 205 which is then permanently sealed. In some embodiments, a closed cell foam material constructed insole with an arch chamber or heat resistant bag 205 may be used where the resin composition may be injected or sealed into the arch chamber or heat resistant bag 205.

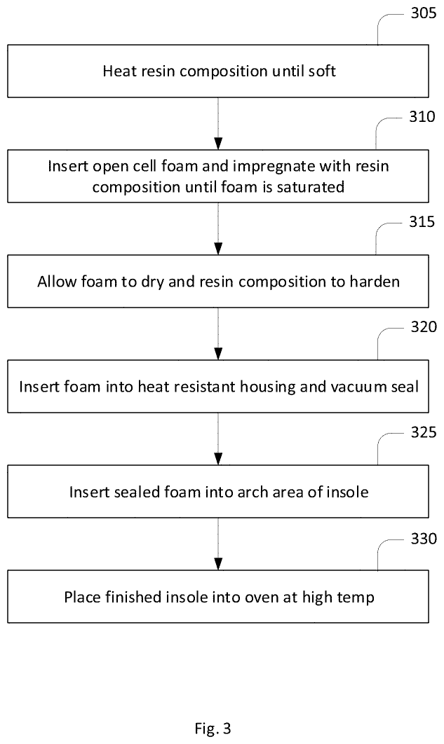

FIG. 3 illustrates a flow chart of an exemplary method of customizing an insole 200 in accordance with an embodiment of the present invention. In a step 305, the resettable or reformable resin composition may be heated until sufficiently soft. After the resettable or reformable resin composition becomes soft enough, at a Step 310, the open cell foam 210 may be inserted and impregnated with the resettable or reformable resin composition until the open cells of the foam 210 is sufficiently saturated. After the foam 210 is sufficiently saturated with the resin composition, at Step 315 allow time for the foam 210 to dry and the resin composition to harden. After the foam 210 is sufficiently dry as to no longer be in a liquid form and the resin composition is sufficiently hardened to no longer easily change shape by a weight of a body, the foam 210, saturated with the resin composition, may be inserted into a heat resistant housing 205 and vacuum sealed. After the foam 210 is inserted and sealed in the heat resistant housing 205, at Step 325 the sealed foam 210 may be inserted into the predetermined arch area of the insole 200. After the sealed foam may be inserted into the insole 200, at Step 330, the sealed foam and insole 200 may be placed into an oven at high temperature, by way of example, not limitation, about 170 degrees F. for 5-8 minutes or until arch pad may be soft enough to be reshaped or deformed by the weight of the body. If the heat activated and remoldable resin composition becomes hard before molding, heat the resettable and reformable resin composition and warm the insole 200 to the proper temperature until the impregnated arch foam becomes soft, in some way that it is optional. By way of an example, and not limitation, in order to warm the insole 200, insole 200 may be placed into an oven at high temperature, such as 170 degrees F. for 5-8 minutes or until arch is soft. In the present non-limiting example, an air heater/blow dryer or conduction heating, if using a metal bag, may be used to warm the insole. When the resin and foam are both soft, the insole, may be molded to any shape. To mold insole 200 to individually fit a user, a foot may be placed on the insole and hold the shape in place with body weight or pressure. By way of an example, and not limitation, when the resin and foam are both soft, the user may place the insoles 200 in a pair of shoes, the shape of the insole 200 may be molded by the user wearing the shoes and walking for five minutes, in order to obtain a dynamic arch shape, in some way, that it is optional. By way of an example, and not limitation, when the resin and foam are both soft, the user places the insole on the floor and stands on the insole for several minutes, in order to obtain a moderate arch shape, in some way, that it is optional. By way of an example, and not limitation, when the resin and foam are both soft, the user sits down on a chair and puts pressure on insoles with user's feet, in order to obtain a more supportive arch shape, in some way, that it is optional. As it cools in temperature, the insole 200 may become hard again, maintaining the custom shape until the resin is reheated to its softening point again. Those skilled in the art, in light of the teachings of the present invention, will readily recognize a multiplicity of alternative and suitable means to heat and mold the insole 200. In many practical applications of the present embodiment, to fit multiple sizes, the finished insole 200 may be trimmed to fit shoe, so long as the puncturing the chamber is avoided. For example, without limitation, if fitting to the arch only, it can be used over many sizes, yet if needed to mold to the entire foot, it would typically be made to each particular size.

An aspect of the present invention is to provide a method to custom mold the insoles 200 so that the user can have a perfect custom fitting shoe in length, width and height even though every person has different shapes of feet. The resulting arch support is very firm in the same way as a custom orthotic from a lab without the expensive cost and time consuming process of having a custom orthotics made professionally. The insole 200 is recustomizable and will expand again to full height once reheated.

Some alternative embodiments or the present invention may provide for custom molded shoe inserts for supporting a narrow foot in a wider shoe and/or supporting a shorter length foot in a longer shoe. In some alternate embodiment of the present invention, custom molded insets may provide for head support such as. But not limited to, in helmets, caps, masks, etc. In some other alternative embodiments, custom molded hand grips may be fitted to the user for gripping for example, but not limited to, tools, handle bars, steering wheels, computer pointing devices, etc. In some other embodiments, custom molded inserts may be fitted to the user for body protection devices for example, but not limited to, knee pads, elbow pads, etc. In some other embodiments, custom molded inserts may be fitted to the user for prosthetic devices. In some other embodiments, custom molded inserts may be fitted to the user for denture devices.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA Law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing custom made insoles or inserts for shoes and a method of making them according to the present invention will be apparent to those skilled in the art. Various aspects of the invention have been described above by way of illustration, and the specific embodiments disclosed are not intended to limit the invention to the particular forms disclosed. The particular implementation of the custom made insoles or inserts for shoes and a method of making them may vary depending upon the particular context or application. By way of example, and not limitation, the custom made insoles or inserts for shoes and a method of making them described in the foregoing were principally directed to insoles or inserts implementations; however, similar techniques may instead be applied to side supports in shoes for people with narrow feet to be able to fit well into and use wide shoes, helmets to make them more form fitting to the head, or handle grips to take on one's hand shape for best gripping, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
heating a resin composition, wherein said resin composition comprises a heat activated resin composition that is configured to be operable for remolding by applying heat at a predetermined temperature;
impregnating a foam material with said heat activated and remoldable resin composition, in which said foam material is configured to accept said heat activated and remoldable resin composition;
saturating said foam material with said heat activated and remoldable resin composition, wherein said foam material comprises a cell foam structure that is operable to be impregnated with said heat activated and remoldable resin composition, and wherein said foam material saturated with said heat activated and remoldable resin composition is configured to be operable for customizing into an insole shape molded implement;
inserting said impregnated foam material into a chamber implement, in which said chamber implement comprises a heat resistant material;
sealing said chamber implement to generally avoid a leakage of said foam material saturated with said heat activated and remoldable resin composition;
inserting said sealed chamber implement in an insole implement, wherein said insole implement comprises at least an arch pad area that is configured to accept said heat activated and remoldable resin composition in said sealed chamber implement; and
applying a pressure on said sealed chamber implement, wherein said pressure is configured to create at least a shaped or molded insole implement, and wherein said shaped or molded insole mold implement is configured to be operable for maintaining said shape or mold as said heat activated and remoldable resin composition in said sealed chamber implement cools in temperature.

2. The method of claim 1, further comprising the steps of reheating said impregnated foam material in said sealed chamber implement for remolding.

3. The method of claim 2, wherein said insole implement is remoldable to a different customized shape by reheating said heat activated and remoldable resin composition in said sealed chamber implement.

4. The method of claim 3, wherein said reheating is configured to be operable for enabling an inherent restoring force of said foam to restore said insole mold implement to its original shape.

5. The method of claim 4, further comprising the steps of placing a top layer on said chamber implement and said bottom layer to seal said insole implement.

6. The method as recited in claim 1, in which said chamber comprises a temperature resistant bag.

7. The method of claim 6, in which said temperature resistant bag comprises an aluminum vacuum sealed bag.

8. The method of claim 5, in which said top layer comprises a close cell foam material.

9. The method of claim 1, in which said foam material comprises an open cell structure.

10. The method of claim 1, in which said insole mold implement being subsequently heated is positionable in a shoe with the user inserting a foot into the shoe to mold the foam material.

11. The method of claim 10, in which the user walks during the molding process.

12. The method of claim 1, in which the user remolds said foam material by reheating said foam material.

13. The method of claim 1, a body weight of the user is applied during the molding process.

14. An apparatus comprising:
a resin composition, wherein said resin composition is a heat activated resin composition that is configured to be remoldable with application of heat at a predetermined temperature;
a foam material, wherein said foam material is impregnated with said resin composition where said foam material is configured to be operable for saturating said heat activated and remoldable resin composition;
a chamber implement, in which said chamber implement comprises a heat resistant material, wherein said chamber implement is configured to enclose said foam material impregnated with said heat activated and remoldable resin composition, and wherein said chamber implement comprises a substantially sealed chamber implement to resist a leakage of said foam material saturated with said heat activated and remoldable resin composition;
an insole implement, in which said insole implement comprises an insole section and an arch pad area, wherein said arch pad area is configured to be operable for accepting said chamber implement enclosing said foam material impregnated with said heat activated and remoldable resin composition;
wherein said chamber implement enclosing said foam material impregnated with said heat activated and remoldable resin composition is operable for customizing or personalizing said insole implement;
wherein said insole implement is configured to be operable for maintaining a molded shape as said heat activated and remoldable resin composition in said sealed chamber implement cools in temperature; and
wherein said insole implement is further configured to be operable for being remolded to a different shape by reheating said heat activated and remoldable resin composition in said sealed chamber implement.

15. The apparatus of claim 14, in which said insole implement further comprises an arch pad area being operable for receiving said chamber implement enclosing said foam material impregnated with said heat activated and remoldable resin composition.

16. The apparatus of claim 15, further comprising a top layer being configured for sealing said chamber implement enclosing said foam material impregnated with said heat activated and remoldable resin composition to said insole implement.

17. The apparatus of claim 16, in which said chamber implement comprises a temperature resistant bag.

18. The apparatus of claim 17, in which said temperature resistant bag comprises an aluminum vacuum sealed bag.

19. The apparatus of claim 14, in which said foam material comprises an open cell structure that is operable for absorbing said heat activated and remoldable resin composition.

20. An apparatus comprising:
means for being remoldable with application of heat at a predetermined temperature;
means for absorbing said remoldable means, wherein said remoldable means is operable for saturating said absorbing means;
means for enclosing said absorbing means, wherein said enclosing means comprises a substantially sealed enclosing means configured to resist a leakage of said absorbing means saturated with said remoldable means;
an insole implement, in which said insole implement comprises:
an insole section; and
an arch pad area, wherein said arch pad area is configured to be operable for accepting said enclosing means;
wherein said insole implement is configured to be operable for maintaining a molded shape as said heat activated and remoldable resin composition in said sealed chamber implement cools in temperature; and
wherein said insole implement is further configured to be operable for being remolded to a different shape by reheating said enclosing means containing said absorbing means saturated with said remoldable means.
